(19) United States
(12) Patent Application Publication
(10) Pub. No.: US 2025/0055359 A1
(43) Pub. Date: Feb. 13, 2025

(54) METHOD FOR PRODUCING A ROTOR OF AN ELECTRIC MOTOR

(71) Applicant: MAHLE International GmbH, Stuttgart (DE)

(72) Inventors: Tim Male, Telford (GB); Peter Sever, Murska Sobota (SI)

(21) Appl. No.: 18/718,016

(22) PCT Filed: Nov. 15, 2022
(86) PCT No.: PCT/EP2022/081959

§ 371 Date: Jun. 7, 2024

(30) Foreign Application Priority Data
Dec. 8, 2021 (DE) 10 2021 213 955.8

(51) Int. Cl. H02K 15/12; H02K 1/276

(52) U.S. Cl. CPC H02K 15/12; H02K 1/276; H02K 2201/06

(57) ABSTRACT

The present invention relates to a method for producing a rotor (1) of an electric motor (2) with laminated cores (4) arranged on a rotor shaft (3), in which—at least two laminated cores (4) twisted relative to one another in the circumferential direction (5) with magnet pockets (6) and magnets (7) arranged therein are arranged on the rotor shaft (3),—in the axial direction (8) between two laminated cores (4) at least one perforated disc (9) with at least one opening (10) is arranged such that the opening (10) overlaps and connects two magnet pockets (6) of two laminated cores (4) adjacent to the perforated disc (9),—a gap between the magnet pockets (6) and the magnets (7) is filled by means of a hardening casting compound (11) wherein the casting compound (10) flows through the opening (10).

### CROSS-REFERENCE TO RELATED APPLICATIONS

This application claims priority to German Patent No. application Ser. No. 102021213955.8 filed on Dec. 8, 2021, and to Application Serial No. PCT/EP2022/081959, filed on Nov. 15, 2022, the contents of both of which are hereby incorporated by reference in their entirety.

### TECHNICAL FIELD

The present invention relates to a method for producing a rotor of an electric motor with a laminated core arranged on a rotor shaft. The invention also relates to a rotor produced by this method and to an electric motor with such a rotor.

### BACKGROUND

A rotor for an electrical machine is known from DE 2017 214 309 A1, with at least one laminated core which has a plurality of magnet pockets arranged one after the other in the axial direction of the rotor, in which the respective magnets are accommodated, which are fixed in the magnet pockets by means of a hardened casting compound. The magnet pockets are fluidically connected to one another via at least one distribution system formed in the laminated core, which system has at least one fluid channel for each magnet pocket that is fluidically connected to the respective magnet pocket. The distribution system has at least one distribution channel common to the filling channels and fluidically connected thereto, wherein the hardened casting compound extends continuously from magnet pocket to magnet pocket through the distribution system and thereby fixes the rotor.

To fix magnets in the magnet pockets of a rotor and to improve the thermal connection between them and a laminated core of the rotor, a hardening casting compound is often used which is injected into the magnet pockets of the rotor. This casting compound flows through the entire rotor, which consists of individual laminated cores (stacks). These laminated cores are twisted relative to each other due to a torque triple. In order for the casting compound to flow through the entire rotor, correspondingly large cross-sectional overlaps of the individual magnet pockets are required, taking into account the so-called skewing angle, which in turn leads to correspondingly large magnet pockets, which in turn reduce the torque density of the entire electric motor and are therefore undesirable.

The present invention therefore addresses the problem of providing a method for producing a rotor by means of which the disadvantages known from the prior art can be overcome.

This problem is solved according to the invention by the subject matter of the independent claims. Advantageous embodiments are the subject matter of the dependent claims.

The present invention is based on the general idea of creating a passage that is essentially continuous in the axial direction in laminated cores arranged on a rotor shaft, through which a casting compound, for example an epoxy resin, can be pressed from one end face to the other end face, thereby fixing the rotor and the magnets located in its magnet pockets. In the method according to the invention for producing a rotor of an electric motor with laminated cores arranged on the rotor shaft, at least two laminated cores rotated relative to one another in the circumferential direction with magnet pockets and magnets arranged therein and at least one perforated disk with at least one opening in the axial direction between the two laminated cores are arranged on the rotor shaft in such a way that the opening connects two magnet pockets of two laminated cores adjacent to the perforated disk opposite one another. The magnet pocket of the first laminated core thus overlaps the opening in the perforated disc, which in turn overlaps the magnet pocket of the second laminated core. Subsequently, a gap between the magnet pockets and the magnets is filled using a casting compound, for example an epoxy resin, wherein the casting compound flows through the opening and is preferably pressed from one end face through the magnet pockets or the opening(s) of the perforated disc(s) to the other end face of the rotor. This allows the individual magnet pockets to be made sufficiently small, thus ensuring a comparatively high torque density of the electric motor. In addition, an improved thermal connection of the magnets to the associated laminated core can be achieved.

It is advantageous to use an epoxy resin as a casting compound. Such an epoxy resin is, on the one hand, able to hold the respective magnet in the magnet pocket and, when hardened, also to prevent the individual laminated cores from twisting relative to each other or to a perforated disk. Epoxy resin is a good heat exchanger and at the same time electrically insulating.

In an advantageous development of the method according to the invention, the perforated disc is composed of individual sheet metal disks. The sheet metal disks used to produce the perforated disk can be made of the same material as the sheet metal disks for the laminated cores. In particular, sheet metal disks with an axial thickness d of approx. 0.2 mm can be used, which enables extremely finely adjustable adjustment with regard to the axial extension of the perforated disks. By using electrical sheets not only for the laminated cores but also for the perforated disk(s), the torque density of the electric motor can also be increased.

In a further advantageous embodiment of the method according to the invention, a web extends through at least one opening of a perforated disk, which web fixes two adjacent magnets in the axial direction. The openings provided in the perforated discs essentially serve as passage openings for the casting compound, wherein a web crossing the opening also provides axial fixation of two magnets adjacent to the respective perforated disc in their magnet pockets. Such a web or crossbar crossing the opening also serves to stiffen the perforated disc and thus increase its rigidity, thereby improving its handling. In addition, such a web can also reduce the amount of casting compound required. It is evidently obvious that the web crossing the opening does not have to cross the opening completely, but can simply be designed as a cantilever arm protruding into the opening. Such a cantilever arm also provides axial fixation of two adjacent magnets.

It is advantageous to insert at least one magnet in a form-fitting manner into an associated magnet pocket. In order to achieve the highest possible torque density of the entire electric motor, it is desirable to fill the magnet pocket as completely as possible with a magnet. Furthermore, a form-fitting connection between the magnet and the corresponding magnet pocket means that the respective magnet can be fixed in the magnet pocket even without casting compound.

The present invention is further based on the general idea of producing a rotor for an electric motor according to the method described in the previous paragraphs. Such a rotor is characterized by a high torque density and thus high performance as well as a reliable fixation of the individual laminated cores to one another.

The present invention is further based on the general idea of providing an electric motor with such a rotor. This means that the advantages described with regard to the rotor can also be transferred to the electric motor.

Other important features and advantages of the invention emerge from the dependent claims, from the drawings, and from the associated figure description based on the drawings.

It is understood that the features mentioned above and those yet to be explained below may be employed not only in the respective specified combination, but also in other combinations or alone, without departing from the scope of the present invention.

Preferred exemplary embodiments of the invention are shown in the drawings and are explained in more detail in the following description, wherein same reference numerals refer to same or similar or functionally same components.

### BRIEF DESCRIPTION OF THE DRAWINGS

In particular, schematically:

FIG. 1 shows a sectional view through a rotor produced according to the method according to the invention,

FIG. 2 shows a section of a perforated disc in the region of an opening with a flow path of a casting compound,

FIG. 3 shows a front view of a laminated core with magnets arranged in its magnet pockets and a perforated disk.

### DETAILED DESCRIPTION

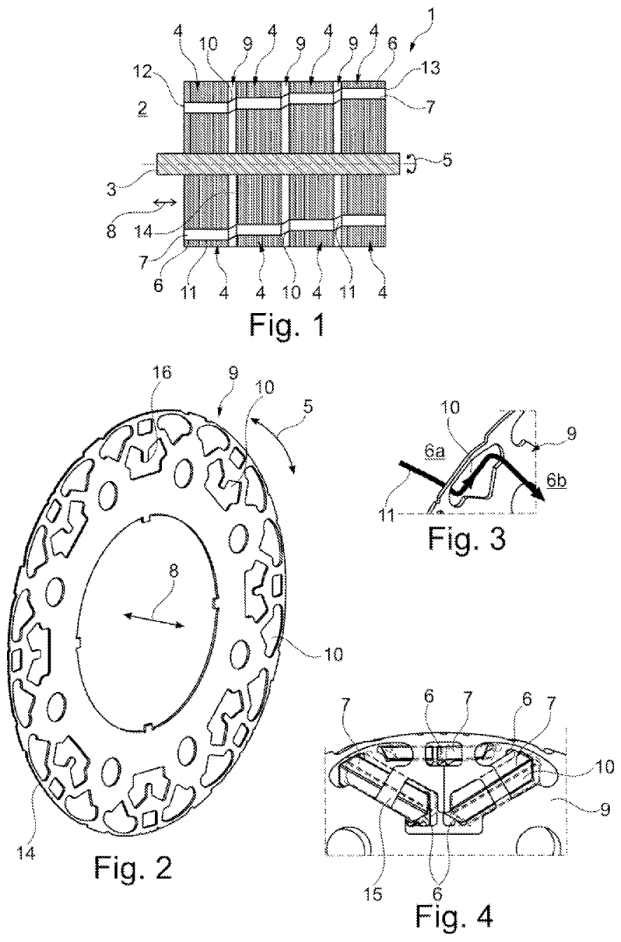

According to FIG. 1, a rotor 1 of an electric motor 2 according to the invention has laminated cores 4 arranged on a rotor shaft 3. These are twisted relative to each other in the circumferential direction in order to achieve a high torque density. Each of these laminated cores 4 has magnet pockets 6 (see also FIG. 4), in which corresponding magnets 7 are arranged. According to the invention, a perforated disk 9 (see also FIGS. 2 to 4) with at least one opening 10 is arranged in the axial direction 8 between two adjacent laminated cores 4, wherein the perforated disk 9 is arranged between two laminated cores 4 in such a way that its opening 10 connects two adjacent magnet pockets 6 to one another. The opening 10 thus overlaps the magnet pocket 6, for example in relation to FIG. 1 of a laminated core 4 arranged to the right of the respective perforated disk 9 and a laminated core 4 arranged to the left of the respective perforated disk 9. In order to be able to achieve a stable connection between the individual laminated cores 4 despite the magnet pockets 6 of the individual laminated cores 4 being rotated in the circumferential direction, a gap between the individual magnet pockets 6 and the magnets 7 arranged therein is cast using a casting compound 11, for example an epoxy resin, wherein the casting compound 11 is pressed into the gap, for example at a point 12 (see FIG. 1), until it emerges again at a point 13 on an opposite side of the rotor 1. The individual openings 10 thus represent passage channels for the casting compound 11.

The perforated disk 9 (see FIG. 2) can also be composed of individual sheet metal disks 14, which are preferably made of the same material, for example an electrical sheet, as the laminated cores 4. A thickness d of the respective sheet metal disks 14 can be, for example, 0.2 mm.

In addition, a web 15 can extend through at least one of the openings 10, which web either completely crosses the respective opening 10 (see FIG. 4) and thereby connects opposite sides of the opening 10 with each other, or merely protrudes into the opening 10 in the manner of a cantilever arm 16 (see FIG. 2). Such a web 15 or cantilever arm 16 represents an axial fixation for magnets 7 arranged in two axially adjacent magnet pockets 6.

At least one of the magnets 7 can be inserted in a form-fitting manner into an associated magnet pocket 6, whereby the gap to be filled with casting compound 11 can be reduced and a torque density or power density of the electric motor 2 can thus be increased.

All in all, the perforated disks 9 provided can ensure a reliable fixing of individual laminated cores 4 to one another.

Looking again at FIG. 3, it can be seen how, when the gaps are filled, the casting compound 11 first flows through a first magnet pocket 6a via the opening 10 in the perforated disk 9 into a second magnet pocket 6b and thereby fixes the laminated cores 4 arranged adjacent to the perforated disk 9 to the same perforated disk 9. The laminated cores 4 are not shown for the sake of clarity.

1. A method for producing a rotor (1) of an electric motor (2) with laminated cores (4) arranged on a rotor shaft (3), in which
at least two laminated cores (4) twisted relative to one another in the circumferential direction (5) with magnet pockets (6) and magnets (7) arranged therein are arranged on the rotor shaft (3),
in the axial direction (8) between two laminated cores (4) at least one perforated disc (9) with at least one opening (10) is arranged such that the opening (10) overlaps and connects two magnet pockets (6) of two laminated cores (4) adjacent to the perforated disc (9),
a gap between the magnet pockets (6) and the magnets (7) is filled by means of a hardening casting compound (11) which flows through the opening (10).

2. The method according to claim 1,
characterized in that
an epoxy resin is used as the casting compound (10).

3. The method according to claim 1 or 2,
characterized in that,
the perforated disc (9) is composed of individual sheet metal discs (14).

4. The method according to claim 3,
characterized in that,
sheet metal discs (14) with a thickness d of approximately 0.2 mm are used.

5. The method according to any one of the preceding claims,
characterized in that
a web (15) or cantilever arm (16) extends through at least one opening (10), which fixes two adjacent magnets (7) in the axial direction (8).

6. The method according to any one of the preceding claims,
characterized in that
that at least one magnet (7) is inserted in a form-fitting manner into an associated magnet pocket (6).

7. A rotor (1) for an electric motor (2), produced by a method according to any one of the preceding claims.

8. An electric motor (2) with a rotor (1) according to claim 7.
